(19) United States
(12) Patent Application Publication
(10) Pub. No.: US 2026/0197913 A1
(43) Pub. Date: Jul. 9, 2026

(54) Pulse Width Modulation Dimming in a Light Emitting Diode Driver

(71) Applicant: TEXAS INSTRUMENTS INCORPORATED, Dallas, TX (US)

(72) Inventors: Weibing Jing, Plano, TX (US); Montu Doshi, Boulder, CO (US)

(21) Appl. No.: 19/013,303

(22) Filed: Jan. 8, 2025

(51) Int. Cl. H05B 45/325; H05B 45/3725

(52) U.S. Cl. CPC H05B 45/325; H05B 45/3725

(57) ABSTRACT

An apparatus includes a sample-and-hold circuit having an input and an output. A switching converter has an output and an amplifier. The amplifier has first and second inputs. The output of the switching converter is coupled to the input of the sample-and-hold circuit. A switch circuit has a first switch input, a first switch output, and a second switch output. The first switch output is coupled to the first input of the amplifier, and the second switch output is coupled to the second input of the amplifier. The first switch input is coupled to the output of the sample-and-hold circuit.

### BACKGROUND

The brightness (intensity) of light produced by light emitting diodes (LEDs) can be controlled by an LED driver. One technique an LED driver can employ to control the brightness of the LEDs' light is pulse width modulation (PWM) dimming. In PWM dimming, a PWM signal is provided to the LED driver. The frequency and duty cycle of the PWM controls the on and off state of the LEDs. For example, when the PWM signal is logic high, a switching converter within the LED driver provides current to the LEDs, and when the PWM signal is logic low, the switching converter is decoupled from the LEDs thereby causing the LEDs to turn off. The frequency of the PWM signal is larger than the temporal frequency of the human eye—that is, the human eye does not perceive the LEDs to blink on and off. Instead, the human eye perceives continuous light produced by the LEDs but at a brightness level proportional to the duty cycle of the PWM signal.

### SUMMARY

In one example, an apparatus includes a sample-and-hold circuit having an input and an output. A switching converter has an output and an amplifier. The amplifier has first and second inputs. The output of the switching converter is coupled to the input of the sample-and-hold circuit. A switch circuit has a first switch input, a first switch output, and a second switch output. The first switch output is coupled to the first input of the amplifier, and the second switch output is coupled to the second input of the amplifier. The first switch input is coupled to the output of the sample-and-hold circuit.

In another example, an apparatus includes an amplifier having an output. A sample-and-hold circuit has an input and an output. The input of the sample-and-hold circuit is coupled to the output of the amplifier. A first switch has first and second switch terminals. The first switch terminal is coupled to the output of the amplifier. A second switch has third and fourth switch terminals. The third switch terminal is coupled to the output of the sample-and-hold circuit. The fourth switch terminal is coupled to the second switch terminal.

In yet another example, a light emitting diode (LED) driver includes a switching converter having first and second inputs and a terminal. A sample-and-hold circuit has an input and an output. The input of the sample-and-hold circuit is coupled to the terminal of the switching converter. A switch has a switch terminal and a control terminal. The switch terminal is coupled to the output of the sample-and-hold circuit. The LED driver has a pulse width modulation (PWM) input, and the control terminal is coupled to the PWM input.

### BRIEF DESCRIPTION OF THE DRAWINGS

FIG. 1 is a schematic diagram of an LED driver coupled to one or more LEDs, in an example.

FIG. 2 includes waveforms illustrating the operation of the LED driver of FIG. 1, in an example.

FIG. 3 is a schematic diagram of an LED driver which includes a sample-and-hold circuit, in an example.

FIG. 4 includes waveforms illustrating the operation of the LED driver of FIG. 3, in an example.

FIG. 5 is a schematic diagram of an LED driver which includes a sample-and-hold circuit, in another example.

FIG. 6 includes waveforms illustrating the operation of the LED driver of FIG. 5, in an example.

### DETAILED DESCRIPTION

The same reference numbers or other reference designators are used in the drawings to designate the same or similar (either by function and/or structure) features.

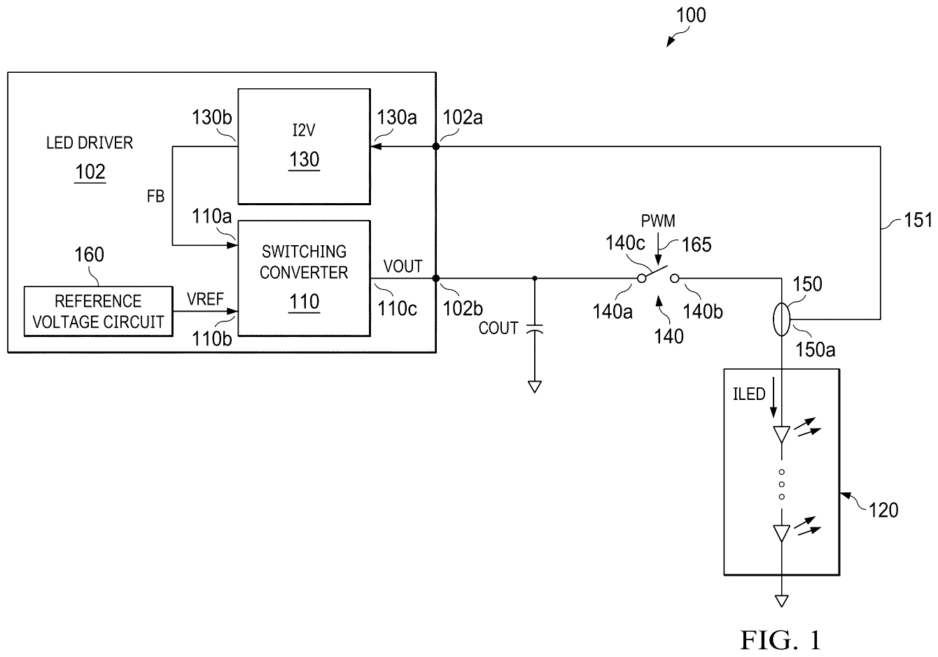

FIG. 1 is a schematic diagram of illumination system 100 including an LED driver 102, a switch 140, LEDs 120, a capacitor COUT, and a current sense circuit 150. LEDs 120 may include a single LED or multiple LEDs coupled in series. LED driver 102 has an input 102a and an output 102b. Switch 140 may be implemented as a transistor (e.g., a field effect transistor) and may be external to LED driver 102 or part of LED driver 102. Switch 140 has switch terminals 140a and 140b and a control input 140c. Output 102b of LED driver 102 is coupled to switch terminal 140a and one terminal of capacitor COUT. The other terminal of capacitor COUT is coupled to ground. Switch terminal 140b is coupled LEDs 120. Current sense circuit 150 may be coupled between switch 140 and LEDs 120 or may be part of switch 140 or LEDs 120. When switch 140 is closed, current ILED flows through LEDs to ground, and LEDs 120 generate light.

Current sense circuit 150 has an output 150a and generates a current 151 at its output 150a that is proportional to current ILED. LED driver 102 includes a switching converter 110, a current-to-voltage (I2V) converter 130, and a reference voltage circuit 160. I2V converter 130 has an input 130a and an output 130b. Input 130a is coupled to input 102a of LED driver 102 and, accordingly, to the output 150a of current sense circuit 150. Switching converter 110 has inputs 110a and 110b and an output 110c. The input 110a is coupled to the output 130b of I2V converter 130. The input 110b is coupled to the reference voltage circuit 160, which generates a reference voltage VREF to the input 110b of switching converter 110. Switching converter 110 generates an output voltage VOUT at its output 110c, which is coupled to the output 102b of LED driver 102. Switching converter 110 may be a buck converter, a boost converter, a buck-boost converter, or other type of switching converter.

A PWM signal 165 may be generated by an external device such as a microcontroller unit (MCU). PWM signal 165 is provided, via a PWM input to the LED driver, to the control input 140c of switch 140. In one example, when the PWM signal 165 is logic high, switch 140 closes, and when PWM signal 165 is logic low, switch 140 opens. Switch 140 being open and closed corresponds to a transistor, which may be used to implement switch 140 being off and on, respectively.

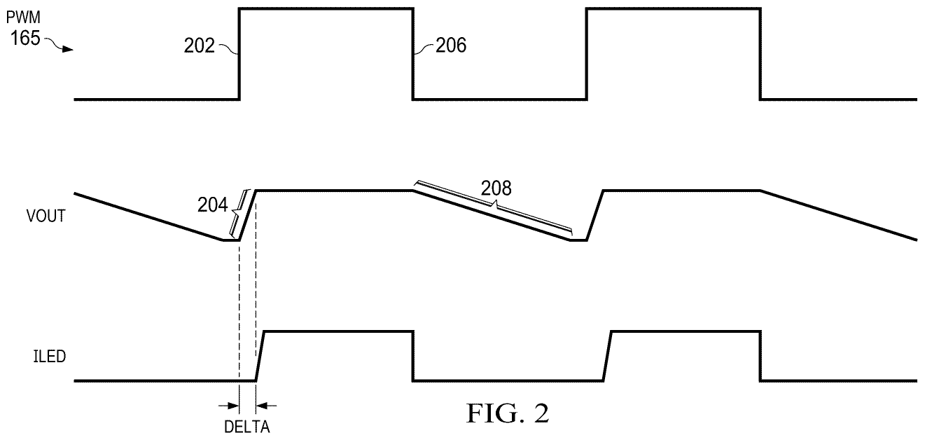

FIG. 2 includes waveforms illustrating the operation of LED driver 102 in FIG. 1. FIG. 2 also illustrates a problem with LED driver 102. The waveforms in FIG. 2 include the PWM signal 165, the output voltage VOUT, and the LED current ILED. In response to the PWM signal 165 being logic low, switch 140 is open and the output voltage VOUT falls to approximately equal to 0V. In response to rising edge 202 of the PWM signal 165, switch 140 closes and current from switching converter 110 begins to charge capacitor COUT. Accordingly, output voltage VOUT rises as indicated at 204. Eventually, VOUT becomes large enough to turn on LEDs 120. For example, a serially-connected string of LEDs will turn on when the output voltage VOUT is larger than the sum of the turn-on voltages of the individual LEDs. When the output voltage VOUT reaches that level, current ILED begins to flow. Accordingly, due to the ramp up of output voltage VOUT, LEDs 120 turn on after a time delay, DELTA, following rising edge 202 of the PWM signal 165. Upon the subsequent falling edge 206 of the PWM signal 165, switch 140 opens, current ILED ceases to flow, the LEDs 120 turn off, and output voltage VOUT decreases as shown at 208. Time delay DELTA results in the duty cycle of current ILED being less than the duty cycle of the PWM signal 165. Accordingly, the brightness level of light produced by LEDs 120 is smaller than the target level otherwise specified by the duty cycle of the PWM signal 165.

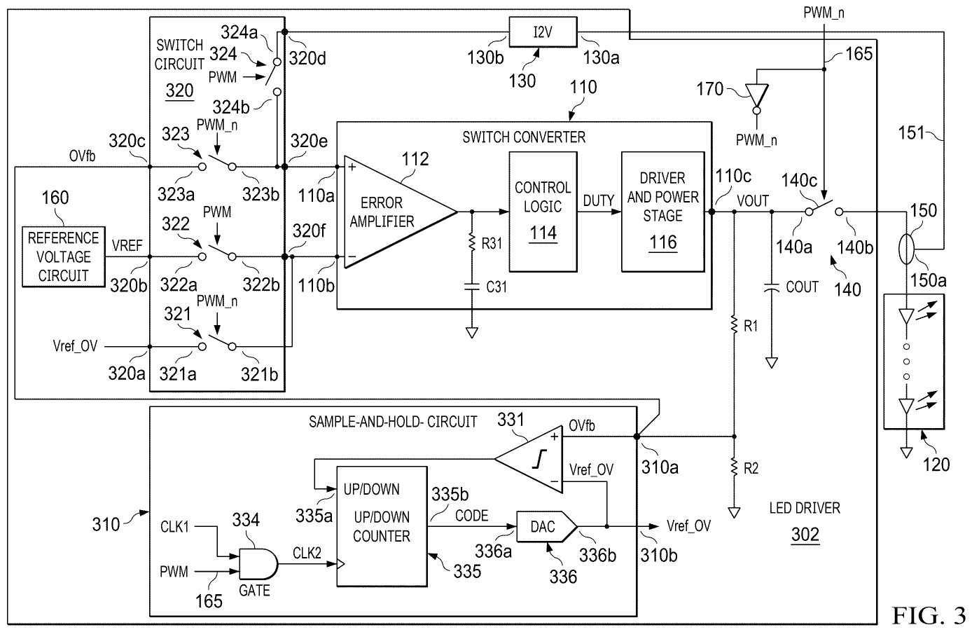

FIG. 3 is a schematic diagram of an LED driver 302 coupled to LEDs 120, in another example. LED driver 302 samples and holds the output voltage VOUT when LEDs 120 are on and then causes switching converter 110 to continue to output VOUT when LEDs 120 are off. Consequently, output voltage VOUT does not experience the drop illustrated in FIG. 2. As a result of output voltage VOUT maintaining a constant level, the duty cycle of LED current ILED approximately matches the duty cycle of the PWM signal 165.

In FIG. 3, LED driver 302 includes switching converter 110, I2V converter 130, and reference voltage circuit 160, as described above. A description of switching converter 110, I2V converter 130, and reference voltage circuit 160 is provided above and is not repeated here. LED driver 302 also includes an inverter 170, a sample-and-hold circuit 310 and a switch circuit 320. Inverter 170 receives the PWM signal 165 at its input and generates a logical inverse of the PWM signal (PWM_n) at its output.

Switch circuit 320 has switch inputs 320a, 320b, 320c, and 320d and switch outputs 320e and 320f. Switch outputs 320e and 320f are coupled to inputs 110a and 110b, respectively, of switching converter 110. Sample-and-hold circuit 310 has an input 310a and an output 310b. The signal at input 310a is OVFB and the signal at output 310b is VREF_OV, explained below. The input 310a of sample-and-hold circuit 310 is coupled to the switch input 320c. The output 310b of sample-and-hold circuit 310 is coupled to the switch input 320a. Reference voltage circuit 160 is coupled to the switch input 320b. The output 130b of I2V converter 130 is coupled to switch input 320d. Switch circuit 320 includes switches 321, 322, 323, and 324 (e.g., transistors). Switch 321 has switch terminals 321a and 321b. Switch terminal 321a is coupled to switch input 320a. Switch terminal 321b is coupled to switch output 320f. Switch 322 has switch terminals 322a and 322b. Switch terminal 322a is coupled to switch input 320b. Switch terminal 322b is coupled to switch output 320f. Switch 323 has switch terminals 323a and 323b. Switch terminal 323a is coupled to switch input 320c. Switch terminal 323b is coupled to switch output 320e. Switch 324 has switch terminals 324a and 324b. Switch terminal 324a is coupled to switch input 320d. Switch terminal 324b is coupled to switch output 320e.

Control inputs of switches 321-324 receive either the PWM signal 165 or its logical inverse PWM_n. Switches 321 and 323 receive PWM_n, and switches 322 and 324 receive the PWM signal 165. In one example, when the PWM signal 165 is logic high and PWM_n is logic low, switches 322 and 324 are closed and switches 321 and 323 are open. Similarly, when the PWM signal 165 is logic low and PWM_n is logic high, switches 321 and 323 are closed and switches 322 and 324 are open. Accordingly, in one logic state for PWM signal 165 (e.g., logic high), the output signal from I2V converter 130 and VREF are provided to inputs 110a and 110b, respectively, of switching converter 110, and in the other logic state (e.g., PWM signal logic low), OVFB and VREF_OV are provided to inputs 110a and 110b, respectively, of switching converter 110.

Sample-and-hold circuit 310 includes a comparator 331, an AND gate 334, a counter 335, and a digital-to-analog converter (DAC) 336. AND gate 334 has inputs 334a and 334b. Input 334a receives a clock signal CLK1, and input 334b receives the PWM signal 165. In some examples, a delayed version of the PWM signal 165 is provided to input 334b. Clock signal CLK1 may be, for example, an externally-supplied clock or a clock derived from switching converter 110. AND gate 334 logically ANDs CLK1 and PWM signal 165, thereby gating off CLK1 when PWM signal 165 is logic low and allowing the PWM signal 165 as to pass through AND gate 334 as signal CLK2 to a clock input of counter 335 when the PWM signal 165 is logic high.

In the example of FIG. 3, counter 335 is an up/down counter. In addition to the clock input, counter 335 has a control input 335a and an output 335b. The output of comparator 331 is coupled to the control input 335a of counter 335. In response to a first logic state (e.g., logic high) of the signal at the control input 335a, counter 335 increments its output count value, CODE, upon receipt of a pulse of CLK2 (e.g., a rising edge). In response to a second logic state (e.g., logic low) of the signal at the control input 335a, counter 335 decrements its output count value, CODE, upon receipt of a pulse of CLK2. The output 335b of counter 335 is coupled to an input 336a of DAC 336. DAC 336 converts the input CODE to the signal (e.g., voltage) VREF_OV.

LED driver 302 also includes a voltage divider including, for example, the resistors R1 and R2 coupled in series between the output 110c of switching converter 110 and ground. The connection between resistors R1 and R2 provides the signal (e.g., voltage) OVFB to the input 310a of sample-and-hold circuit 310 and to the positive input of comparator 331. OVFB is a divided-down version of VOUT

$$( e . g . , OVFB = VOUT * \frac{R 2}{R 1 + R 2} ) .$$

The negative input of comparator 331 is coupled to the output 310b of sample-and-hold circuit 310. Comparator 331 compares OVFB to VREF_OV. The signal at the control input 335a of counter 335 is at a logic state based on whether OVFB is larger or smaller than VREF_OV. For example, if VREF_OV is smaller than OVFB, comparator 331 outputs a logic high to the control input 335a, and counter 335 increments its output CODE upon receipt of a pulse of CLK2 thereby causing DAC 336 to increase VREF_OV. If VREF_OV is larger than OVFB, comparator 331 outputs a logic low to the control input 335a, and counter 335 decrements its output CODE upon receipt of a pulse of CLK2 thereby causing DAC 336 to decrease VREF_OV.

Sample-and-hold circuit 310 and switch circuit 320 operate in concert in two different states. The first state is when the PWM signal 165 is logic high, and the second state is when the PWM signal 165 is logic low. In the first state (PWM signal 165 logic high), switch 140 is closed, voltage VOUT is provided to LEDs 120 thereby causing current ILED to flow through the LEDs, and the LEDs generate light. In the first state, AND gate 334 allows CLK1 to pass through the AND gate as CLK2 to thereby clock counter 335. Each pulse of CLK2 causes counter 335 to increment or decrement its output CODE based on whether VREF_OV is larger or smaller than OVFB. As VREF_OV is incrementally adjusted up or down, eventually, VREF_OV becomes approximately equal to OVFB. Accordingly, sample-and-hold circuit 310 samples and holds (retains) output voltage VOUT during the first state. Also, during the first state, switches 322 and 324 are closed and switches 321 and 323 are open. With switch circuit 320 in this configuration, the output of I2V converter is electrically coupled to the input 110a of switching converter 110 thereby providing the signal from I2V converter 130 to input 110a, and reference voltage circuit 160 is electrically coupled to the input 110b of the switching converter thereby providing VREF to the input 110b.

Switching converter 110 includes an amplifier 112 (e.g., an error amplifier), control logic 114, and driver and power stage 116. The positive input of amplifier 112 is coupled to input 110a, and the negative input of amplifier 112 is coupled to input 110b. During the first state (PWM signal 165 logic high), amplifier 112 amplifies the difference between the output signal from I2V converter 130 and VREF. The output of amplifier 112 is coupled to an input of control logic 114. A resistor R31 and capacitor C31 are coupled in series between the output of amplifier 112 and ground. Control logic generates a PWM signal (DUTY), which is different than PWM signal 165, based on the output of amplifier 112. DUTY is provided to driver and power stage 116, which may include gate drivers, transistors, and/or an inductor. The components of driver and power stage 116 may implement the power stage of a buck converter, a boost converter, or a buck-boost converter. The control loop formed by I2V converter 130, amplifier 112, and control logic 114 operates to generate VOUT at a level by which the output signal from I2V 130 is approximately equal to VREF.

During the second state (PWM signal 165 is logic low), switch 140 is open thereby shutting off current ILED to LEDs 120 and the LEDs turn off. Further, switches 321 and 323 are closed and switches 322 and 324 are opened during the second state. With the switch circuit 320 in that configuration, the output 310b of sample-and-hold circuit 310 is electrically coupled to input 110b of switching converter 110 thereby providing the sampled-and-held voltage VREF_OV, which is approximately equal to VOUT during the first state, to the input 110b, and OVFB is provided to the input 110a of switching converter 110. During the second state (PWM signal 165 logic low), the control loop formed by I2V converter 130, amplifier 112, and control logic 114 operates to generate maintain VOUT at approximately the same level of VOUT during the first state thereby avoiding the decrease 208 described above. Accordingly, when the first state again activates (PWM signal 165 becomes logic high), the output voltage VOUT from switching converter is already at the target level.

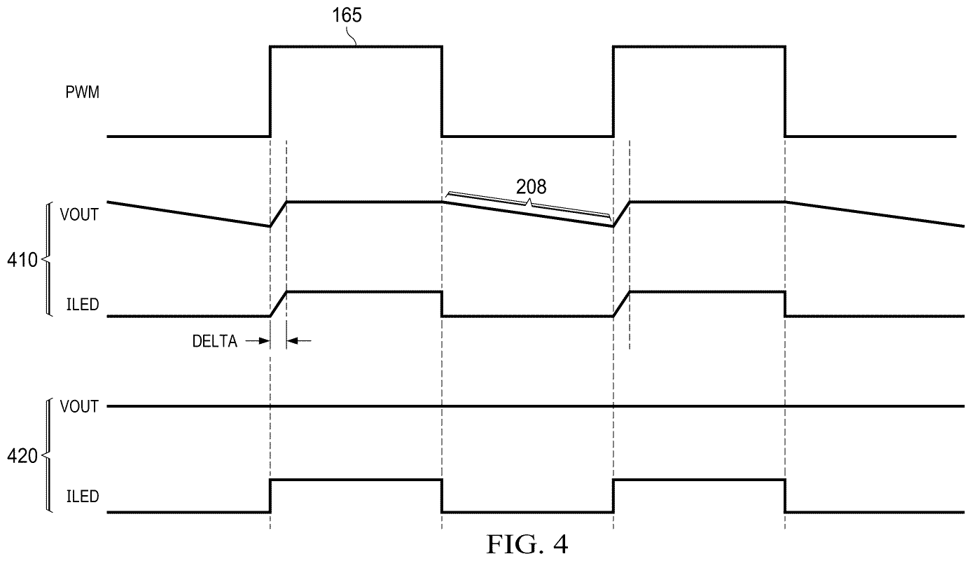

FIG. 4 includes waveforms illustrating the operation of LED driver 302. The waveforms include example waveforms for the PWM signal 165, VOUT, and ILED. A first set 410 of waveforms for VOUT and ILED corresponds to the waveforms for VOUT and ILED in FIG. 2 without the sample-and-hold circuit 310 of FIG. 3. The second set 420 of waveforms for VOUT and ILED corresponds to the waveforms for VOUT and ILED for LED driver 302 of FIG. 3. Instead of the decrease 208 for VOUT during the second state (PWM signal 165 logic low), VOUT in set 420 is maintained at approximately a constant level and does not experience the decrease. Accordingly, LED current ILED of set 420 also does not experience the delay DELTA of set 410 because VOUT is maintained at approximately a constant level.

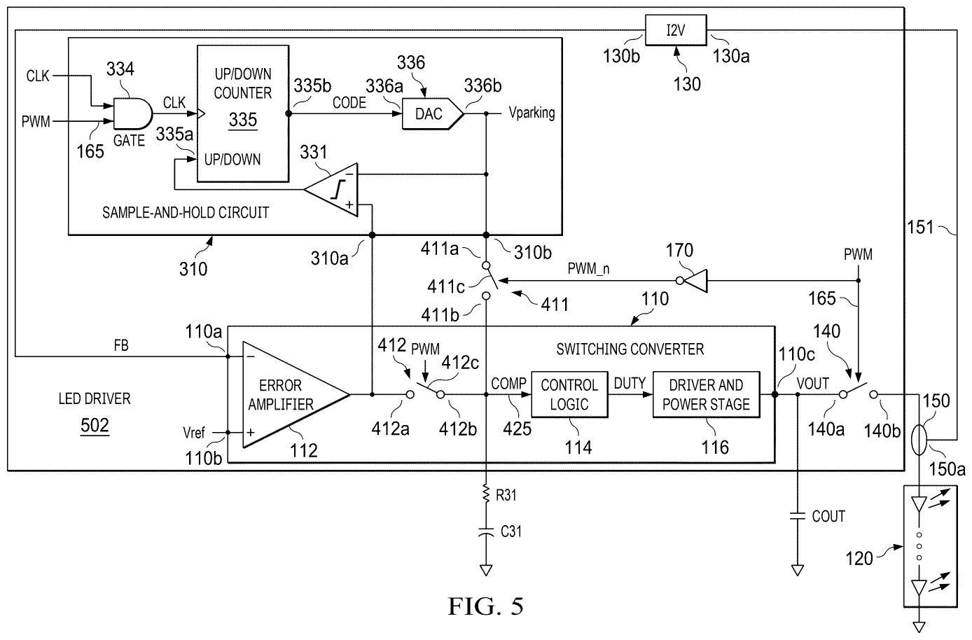

FIG. 5 is a schematic diagram including another example of an LED driver 502. LED driver 502 also includes switching converter 110, I2V converter 130, and sample-and-hold circuit 310. Sample-and-hold circuit 310 in FIG. 5 is coupled to a different terminal of switching converter 110 than sample-and-hold circuit 310 in the example of FIG. 3. Instead of input 310a being coupled via the voltage divider (R1 and R2) to the output 110c of switching converter 110 as in FIG. 3, input 310a in FIG. 5 is coupled to the output of amplifier 112, which generates an output signal COMP. Accordingly, sample-and-hold circuit 310 samples the output signal from amplifier 112. LED driver 502 includes switches 411 and 412 (e.g., transistors). Switch 411 has switch terminals 411a and 411b and a control terminal 411c. Switch 412 has switch terminals 412a and 412b and a control terminal 412c. Terminal 411a is coupled to the output of DAC 336 and to the negative input of comparator 33q. Terminal 412a is coupled to the output of amplifier 112 and to the positive input of comparator 331. Terminals 411b and 412b are coupled together and to the input of control logic 114 and resistor R31. PWM signal 165 is provided to the control terminal 412c of switch 412. Signal PWM_n is provided to the control terminal 411c of switch 411. Accordingly, switch 411 is closed and switch 412 is open when the PWM signal 165 is at a logic high level, and switch 411 is open and switch 412 is closed when the PWM signal 165 is at a logic low level.

When the PWM signal 165 is logic high, switch 140 closes as described above. Further, with PWM signal 165 being logic high, switch 412 closes and switch 411 opens thereby causing sample-and-hold circuit 310 to sample the output signal COMP from amplifier 112. As described above, sample-and-hold circuit 310 generates an output signal from DAC 336 that is approximately equal to the sampled input signal. In the example of FIG. 5, the DAC's output signal is VPARKING. Accordingly, VPARKING is a voltage that is approximately equal to the amplifier's output voltage (COMP). Sample-and-hold circuit 310 samples the amplifier's output signal when PWM diming is on (PWM signal 165 is logic high). When PWM dimming turns off (PWM signal 165 is logic low), switch 412 opens and switch 411 closes. With switch 411 closed, the sampled and held signal VPARKING is provided to resistor R31 and to the input of control logic 114. Accordingly, the COMP signal to the input of control logic 114 is either the output signal from amplifier 112 when the PWM signal 165 is logic high or the signal VPARKING from sample-and-hold circuit 310 when the PWM signal 165 is logic low.

By sampling and holding the output signal from amplifier when the PWM signal 165 is logic high, sample-and-hold circuit 310 is able to maintain the signal to control logic 114 at approximately the same level as the signal generated by amplifier 112. This behavior is technically advantageous because, otherwise, when the PWM signal 165 is logic low, the output signal from amplifier 112 would decrease. By maintaining the COMP signal at the same level when switch 140 is open, the transient response of LED driver 502 is faster than would be the case without sample-and-hold circuit 310.

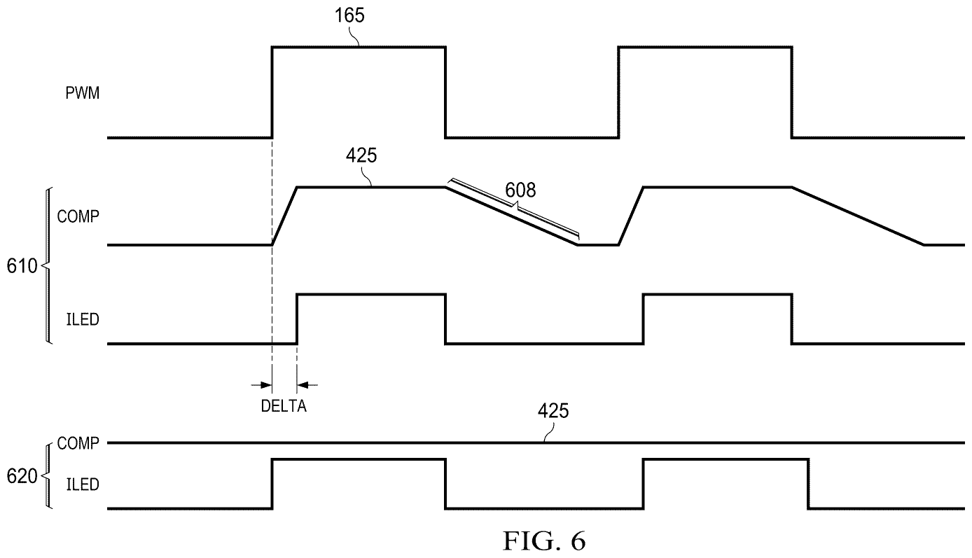

FIG. 6 includes waveforms illustrating the operation of LED driver 502. The waveforms include example waveforms for the PWM signal 165, COMP, and ILED. A first set 610 of waveforms for COMP and ILED corresponds to the waveforms for COMP and ILED without the sample-and-hold circuit 310 of FIG. 5. The second set 620 of waveforms for COMP and ILED corresponds to the waveforms for COMP and ILED for LED driver 502 of FIG. 5. Instead of the decrease 608 for COMP during the second state (PWM signal 165 logic low), COMP in set 620 is maintained at approximately a constant level and does not experience the decrease. Accordingly, LED current ILED of set 620 also does not experience the delay DELTA of set 610 because COMP is maintained at approximately a constant level.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a sample-and-hold circuit having an input and an output;
a switching converter having an output and having an amplifier, the amplifier having first and second inputs, the output of the switching converter coupled to the input of the sample-and-hold circuit; and
a switch circuit having a first switch input, a first switch output, and a second switch output, the first switch output coupled to the first input of the amplifier, and the second switch output coupled to the second input of the amplifier, the first switch input coupled to the output of the sample-and-hold circuit.

2. The apparatus of claim 1, wherein the switch circuit has a second switch input and the switch circuit is configured to receive a signal, and the apparatus further comprises a reference voltage circuit having an output coupled to the second switch input, and the switch circuit is configured to electrically couple the output of the sample-and-hold circuit to the second input of the amplifier responsive to the signal being at a first logic state and electrically couple the output of the reference voltage circuit to the second input of the amplifier responsive to the signal being at a second logic state.

3. The apparatus of claim 2, wherein the switch circuit has a third switch input and a fourth switch input, the third switch input coupled to the input of the sample-and-hold circuit, and the switch circuit is configured to electrically couple the input of the sample-and-hold circuit to the first input of the amplifier responsive to the signal being at the first logic state and electrically couple the fourth switch input to the first input of the amplifier responsive to the signal being at the second logic state.

4. The apparatus of claim 1, wherein the switch circuit includes a switch having first and second switch terminals, the first switch terminal coupled to the output of the sample-and-hold circuit, and the second switch terminal coupled to the second input of the amplifier.

5. The apparatus of claim 1, wherein the sample-and-hold circuit comprises:
a comparator having a first comparator input, a second comparator input, and an output, the first comparator input coupled to the input of the sample-and-hold circuit and the second comparator input coupled to the output of the sample-and-hold circuit;
a counter having a control input and an output, the control input coupled to the output of the comparator; and
a digital-to-analog converter having an input coupled to the output of the counter and having an output coupled to the output of the sample-and-hold circuit.

6. The apparatus of claim 5, wherein the counter is an up/down counter.

7. The apparatus of claim 1, wherein the amplifier has an output, and wherein the switching converter includes a driver having an input coupled to the output of the amplifier.

8. An apparatus, comprising:
an amplifier having an output;
a sample-and-hold circuit having an input and an output, the input of the sample-and-hold circuit coupled to the output of the amplifier;
a first switch having first and second switch terminals, the first switch terminal coupled to the output of the amplifier; and
a second switch having third and fourth switch terminals, the third switch terminal coupled to the output of the sample-and-hold circuit, and the fourth switch terminal coupled to the second switch terminal.

9. The apparatus of claim 8, wherein the first switch is configured to close when the second switch is open, and the second switch is configured to close when the first switch is open.

10. The apparatus of claim 8, further comprising a switching converter, and the switching converter includes the amplifier.

11. The apparatus of claim 8, wherein the sample-and-hold circuit comprises:
a comparator having a first comparator input, a second comparator input, and an output, the first comparator input coupled to the input of the sample-and-hold circuit and the second comparator input coupled to the output of the sample-and-hold circuit;
a counter having a control input and an output, the control input coupled to the output of the comparator; and
a digital-to-analog controller having an input coupled to the output of the counter and having an output coupled to the output of the sample-and-hold circuit.

12. The apparatus of claim 11, wherein the counter is an up/down counter.

13. A light emitting diode (LED) driver, comprising:
a switching converter having first and second inputs and a terminal;
a sample-and-hold circuit having an input and an output, the input of the sample-and-hold circuit coupled to the terminal of the switching converter; and
a switch having a switch terminal and a control terminal, the switch terminal coupled to the output of the sample-and-hold circuit;
wherein the LED driver has a pulse width modulation (PWM) input, and the control terminal is coupled to the PWM input.

14. The LED driver of claim 13, further comprising an inverter having an input and an output, the input of the inverter coupled to the PWM input, and the output of the inverter coupled to control terminal.

15. The LED driver of claim 13, wherein the switch is a first switch, the switch terminal is a first switch terminal, the control terminal is a first control terminal, the first switch has a second switch terminal coupled to the one of the first and second inputs of the switching converter, and the LED driver further comprises:
a second switch having third and fourth switch terminals, the fourth switch terminal coupled to the second switch terminal; and
a reference voltage circuit having an output coupled to the third switch terminal.

16. The LED driver of claim 13, wherein the switching converter is configured to produce an output voltage at the terminal of the switching converter.

17. The LED driver of claim 13, wherein the switching converter includes an amplifier having an output, and the terminal of the switching converter is coupled to the output of the amplifier.

18. The LED driver of claim 17, wherein the switch is a first switch, the switch terminal is a first switch terminal, the first switch has a second switch terminal, and the LED driver further comprises:
a second switch having third and fourth switch terminals, the third switch terminal coupled to the output of the amplifier, and the fourth switch terminal coupled to the second switch terminal.

19. The LED driver of claim 18, wherein the first switch is configured to be closed when the second switch is open, and the second switch is configured to be closed when the first switch is open.

20. The LED driver of claim 13, wherein the sample-and-hold circuit comprises:
a comparator having a first comparator input, a second comparator input, and an output, the first comparator input coupled to the terminal of the switching converter and the second comparator input coupled to the output of the sample-and-hold circuit;
a counter having a control input and an output, the control input coupled to the output of the comparator; and
a digital-to-analog converter having an input coupled to the output of the counter and having an output coupled to the output of the sample-and-hold circuit.
